(19) United States
(12) Patent Application Publication
(10) Pub. No.: US 2016/0307209 A1
(43) Pub. Date: Oct. 20, 2016

(54) APPARATUS, SYSTEM AND METHOD FOR WIRELESSLY COLLECTING DATA CORRESPONDING TO A SECURITY DEVICE

(71) Applicant: Sennco Solutions, Inc., Plainfield, IL (US)

(72) Inventor: Christopher Marszalek, Plainfield, IL (US)

(73) Assignee: SENNCO SOLUTIONS, INC., Plainfield, IL (US)

(21) Appl. No.: 14/689,727

(22) Filed: Apr. 17, 2015

(51) Int. Cl. G06Q 30/02; H04Q 9/00

(52) U.S. Cl. CPC G06Q 30/0201; H04Q 9/00; H04Q 2209/40

(57) ABSTRACT

An apparatus, a system and/or a method provide for wirelessly collecting data corresponding to a product attached to a security device. Security devices may wirelessly transmit status data. An analytics module may monitor and/or capture the status data and/or may determine statistical data related to the product attached to the security device. The analytics module may wirelessly transmit the statistical data to a remote device for further collection and/or analysis.

### BACKGROUND OF THE INVENTION

The present invention relates to an apparatus, a system and a method for wirelessly collecting data corresponding to a product attached to a security device.

A product may be displayed in, for example, a retail store for a consumer to evaluate the product. A security device often affixes to a product to prevent and/or deter theft of the product. A consumer may, for example, lift and/or inspect a product on display to assess its function and/or aesthetics. For example, a consumer may conduct a tactile evaluation and assess the feel, weight, functionality and/or the like of a product. Generally, many consumers may perform such inspections of the same product. Some consumers may conduct a thorough evaluation of a product, whereas others may evaluate the product for a brief duration. Further, some products may be evaluated frequently, whereas other products have infrequent and/or short interactions with the consumer.

Some consumers may ultimately purchase a product after conducting an evaluation. Retailers and/or manufacturers may desire analytic information pertaining to consumer interaction with a product as such information may further guide point-of-sale marketing. However, gauging consumer interest in a product may be expensive, time consuming, difficult to implement, and/or prone to error. Therefore, data pertaining to instances that a consumer evaluates a product is often unavailable.

Retailers and/or manufacturers may have point-of-sale data. Such data, however, is generally limited to a purchase of a product. Moreover, retailers and/or manufacturers may desire more statistical data. For example, data including the quantity of times a certain product is evaluated, the frequency of evaluations, the respective times of day of each evaluation and/or the duration of each respective evaluation, may assist retailers and/or manufacturers in quantifying consumer interest in a certain product. Additionally, such data may focus sales efforts. Manufacturers and/or retailers may desire to obtain such data quickly and/or automatically. Still further, the ability to provide such data to a source remote from the display area is desirable.

A security device may be affixed to a product in many ways. The security device may be attached by an adhesive and/or by a cable to tether the product to a display base. Generally, the tethered cable has a predefined length and/or is retractable. Tethering allows the consumer to manipulate the product; however, tethering simultaneously confines the available degrees of freedom of manipulation of the product. Retailers, vendors, and/or manufacturers may detach the cable from the security device via a key, for example, to allow the consumer to evaluate the product in a less restricted manner. Moreover, a consumer may assess the suitability of a certain product when the product is detached from a cable and/or a security base. For example, a consumer may place a product, such as a mobile device, in a pocket to assess its weight, characteristics and/or aesthetics.

Often, manufacturers and/or retailers may desire information regarding position and/or alarm status of a product attached to a security device. Further, manufacturers and/or retailers may desire information regarding, for example, a respective key that configured a security device.

A need, therefore, exists for an apparatus, system and method for wirelessly collecting data corresponding to a product attached to a security device.

### SUMMARY OF THE INVENTION

The present invention relates to an apparatus, a system and a method for wirelessly collecting data corresponding to a product attached to a security device. The apparatus, the system and/or the method may have an analytics module that may capture status data transmitted in a wireless network. The analytics module may collect the status data and/or determine one or more statistics from the status data. More specifically, the security device may transmit position data, alarm data, and/or battery data. The analytics module may collect the status data and determine statistical data, such as, for example, the quantity of evaluations, the duration of each evaluation, the frequency of evaluations and/or the time of each evaluation of the product. The analytics module may present the statistical data to a user and/or may transmit the statistical data to a remote system for further data collection and/or data analysis.

To this end, in an embodiment of the present invention, a system for wirelessly collecting data corresponding to a product on a display for purchase of the product is provided. A security device is attached to the product, and, a first transceiver is associated with the security device wherein the first transceiver wirelessly transmits status data wherein the status data is indicative of a position of the product. An analytics module is positioned remotely from the security device wherein the analytics module receives the status data and determines statistical data from the status data wherein the statistical data is indicative of a number of lifts of the product wherein a lift corresponds to removal of the product from the position.

In an embodiment, a second transceiver is associated with the analytics module wherein the second transceiver wirelessly transmits the statistical data.

In an embodiment, a base is associated with the display wherein the base docks the security device.

In an embodiment, an alarm is associated with the security device wherein the alarm produces a signal indicative of a disconnect of the security device from the product.

In an embodiment, a computer is connected to the analytics module wherein the computer collects the statistical data.

In an embodiment, an alarm module receives the status data.

In another embodiment, an apparatus for wirelessly collecting data corresponding to a product connected to a security device wherein the product is in a static position and removable to a lifted position is provided. An analytics module is positioned remotely from the security device wherein the analytics module receives status data from the security device wherein the status data is indicative of whether the product is in the static position or the lifted position and further wherein the analytics module determines statistical data from the status data. A transceiver is associated with the analytics module wherein the transceiver wirelessly transmits the statistical data.

In an embodiment, a computer is connected to the analytics module wherein the analytics module transmits the statistical data to the computer.

In an embodiment, an alarm module is positioned remotely from the security device wherein the security device transmits a wireless signal to the alarm module.

In an embodiment, an emitter is positioned remotely from the security device wherein the emitter transmits a wireless signal to the security device.

In an embodiment, a clock is associated with the analytics module wherein the clock identifies a time of day of removal of the product from the static position.

In an embodiment, a memory is associated with the analytics module wherein the memory stores the statistical data.

In another embodiment, a method for wirelessly collecting data corresponding to a product connected to a security device is provided. The method has the steps of receiving a wireless signal from the security device wherein the wireless signal conveys status data wherein the status data is indicative of a position of the product; determining a lift of the product wherein the lift corresponds to removal of the product from the position; determining statistical data from the status data wherein the statistical data is indicative of a number of lifts of the product; and wirelessly transmitting the statistical data.

In an embodiment, the method has the step of determining an evaluation duration of the product that is indicative of a time of the lift of the product.

In an embodiment, the method has the step of determining a removal time of the product that is indicative of a time of day of the lift of the product.

In an embodiment, the method has the step of activating an alarm when the security device is removed from the product.

In an embodiment, the method has the step of determining an evaluation frequency that is indicative of a number of times the product is lifted.

In an embodiment, the method has the step of determining an alarm frequency that is indicative of a number of times an alarm associated with the security device is triggered.

In an embodiment, the method has the step of storing the statistical data in a memory.

In an embodiment, the method has the step of receiving a request for the statistical data.

It is, therefore, an advantage of the present invention to provide a system, an apparatus and/or a method for wirelessly collecting data corresponding to a product attached to a security device.

Another advantage of the present invention is to provide a system, an apparatus and/or a method that may detect a lift of a product and/or the time of day of the lift.

Yet another advantage of the present invention is to provide a system, an apparatus and/or a method that may determine the number of lifts of a product.

Further, an advantage of the present invention is to provide a system, an apparatus and/or a method for determining the duration of a lift of a product.

Still further, an advantage of the present invention is to provide a system, an apparatus and/or a method that may determine the frequency of lifts of a product.

A further advantage of the present invention is to provide a system, an apparatus and/or a method that may detect an alarm condition of a product attached to a security device.

Yet another advantage of the present invention is to provide a system, an apparatus and/or a method that may log data indicating a key that may have disarmed the security device.

Further, an advantage of the present invention is to provide a system, an apparatus and/or a method that may correlate statistical data with sale data.

Another advantage of the present invention is to provide a system, an apparatus and/or a method that may determine and/or collect statistical data corresponding to a product attached to a security device.

Moreover, an advantage of the present invention is to provide a system, an apparatus and/or a method that may display statistical data to a user.

Another advantage of the present invention is to provide a system, an apparatus and/or a method that may update statistical data in real time.

Further, an advantage of the present invention is to provide a system, an apparatus and/or a method that may transmit statistical data to a remote device.

Another advantage of the present invention is to provide a system, an apparatus and/or a method that may provide statistical data to a remote device for collection in real time.

Additional features and advantages of the present invention are described in, and will be apparent from, the detailed description of the presently preferred embodiments and from the drawings.

### DESCRIPTION OF THE DRAWINGS

FIG. 1 illustrates a perspective view of a system for collecting data corresponding to a product attached to a security device in an embodiment of the present invention.

FIG. 2 illustrates a perspective view of a system for collecting data corresponding to a product attached to a security device wherein the product is in a lifted position in an embodiment of the present invention.

FIG. 3 illustrates a perspective view of components of the system for collecting data corresponding to a security device in an embodiment of the present invention.

FIG. 4 illustrates a black box diagram of an analytics module in an embodiment of the present invention.

FIG. 5 illustrates a black box diagram of a security device in an embodiment of the present invention.

FIG. 6 illustrates a perspective view of an alarm module and a key in an embodiment of the present invention.

FIG. 7 illustrates a black box diagram of an alarm module in an embodiment of the present invention.

FIG. 8 illustrates a flowchart for logging an evaluation of a product in an embodiment of the present invention.

FIG. 9 illustrates a flowchart for logging a duration of an evaluation in an embodiment of the present invention.

FIG. 10 illustrates a flowchart for logging a frequency of evaluations in an embodiment of the present invention.

FIG. 11 illustrates a flowchart for logging an alarm condition in an embodiment of the present invention.

FIG. 12 illustrates a flowchart for logging sale data in an embodiment of the present invention.

FIG. 13 illustrates a perspective view of a system for wirelessly collecting and/or transmitting data in an embodiment of the present invention.

### DETAILED DESCRIPTION

The present invention generally relates to an apparatus, a system and a method for wirelessly collecting data corresponding to a product attached to a security device.

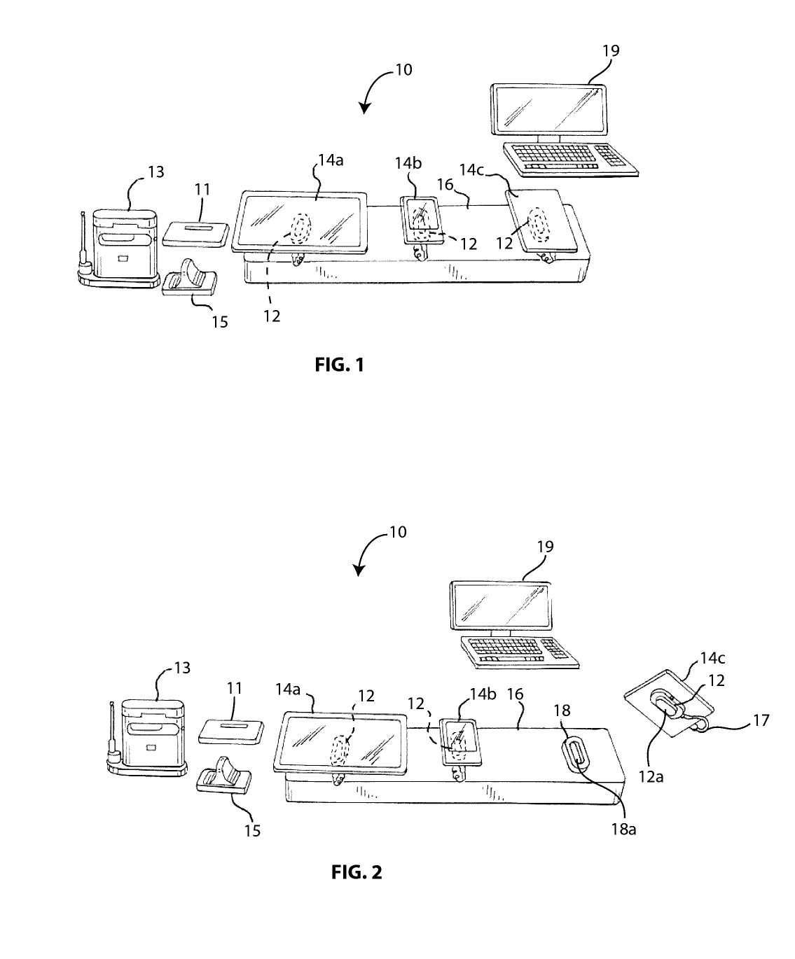

Referring now to the drawings wherein like numerals refer to like parts, FIG. 1 illustrates a system 10 in which an embodiment of the present invention may be implemented. The system 10 may have a product 14A, a product 14B and/or a product 14C that may be positioned and/or located on a display 16, for example, in a retail store, for consumer evaluation. Hereinafter, the product 14A, the product 14B and/or the product 14C will be referred to, collectively, as the product 14. The product 14 may be a portable electronic device, such as, for example, a cellular telephone, tablet computer, MP3 player, camera, GPS device and/or the like. However, it should be understood that the product 14 may be any device displayed and/or sold at, for example, a retail store.

A security device 12 may be affixed to the product 14, for example, via an adhesive, and may dock to a base 18, as shown in FIG. 2, that may be located on the display 16. The base 18 may have a recess 18A that may receive the security device 12. For instance, the security device 12 may have an extended portion 12A that may dock within the recess 18A of the base 18. When the security device 12 is docked, the base 18 may provide power to and/or charge the security device 12 and/or the product 14. On the display 16, the product 14 and/or the security device 12 may be presented in a docked position, i.e. the product 14 and/or the security device 12 may be docked to the base 18. In a retail environment, for example, a consumer may lift the product 14 and the security device 12 from the base 18, as shown in FIG. 2. It should be understood that the lift of the product 14 correspondingly results in the lift of the security device 12. The consumer may evaluate the product 14 and, when finished, may return the product 14 to the base 18.

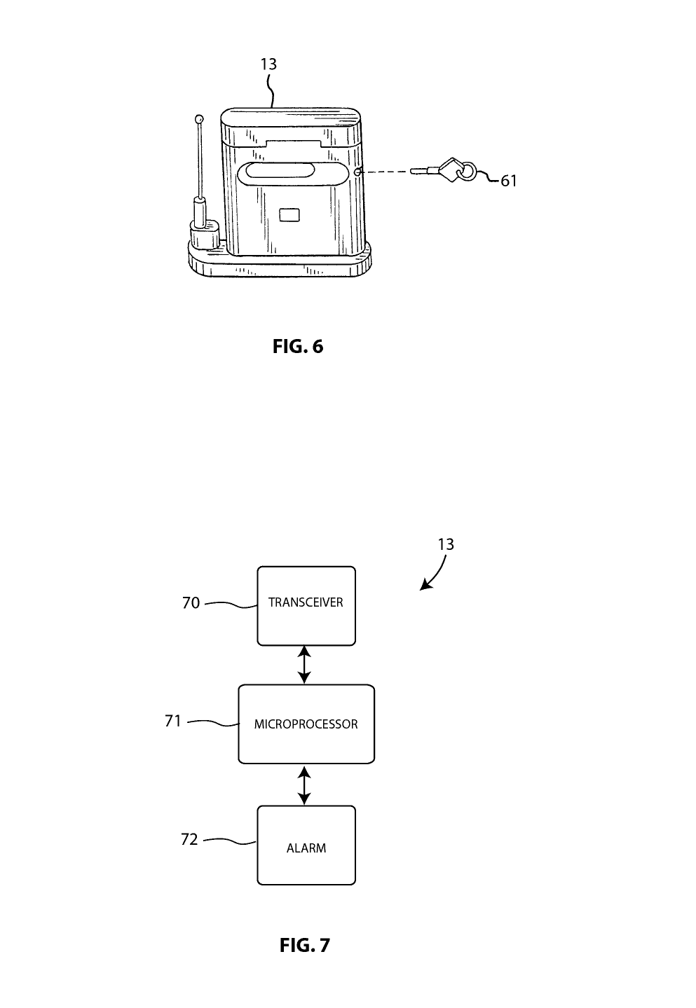

In another embodiment of the present invention, the security device 12 may tether the product 14 to the display 16. For instance, a retractable cable (not shown) may extend from the security device 12 to the base 18. The base 18 and/or the retractable cable may provide power to the security device 12 and/or to the product 14. Moreover, the retractable cable may be disconnected from the security device 12 via a key 61, such as the key 61 as shown in FIG. 6A. To reconnect the security device 12 to the retractable cable, the security device 12 may be placed on the base 18. After reconnecting to the base 18 and/or the retractable cable, the security device 12 and/or the product 14 may resume charging.

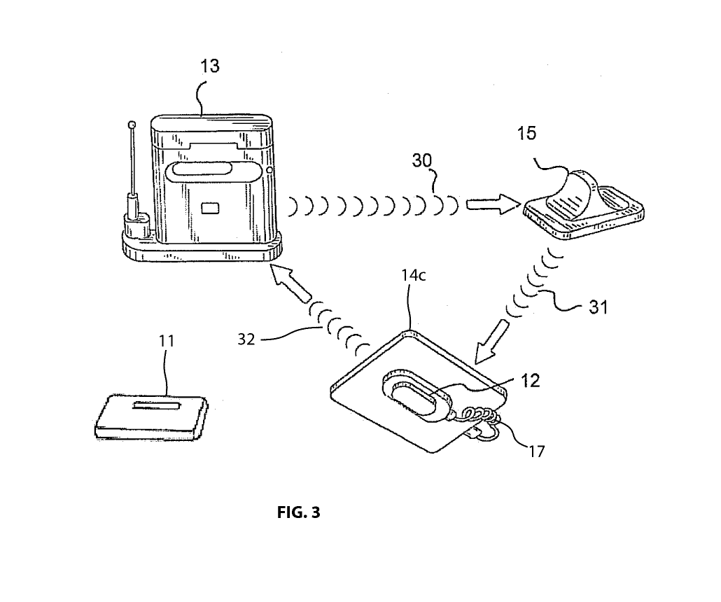

As shown in FIG. 1, the system 10 may also have an analytics module 11, an alarm module 13 and/or an emitter 15. To maintain security when the security device 12 is detached from the retractable cable and/or the base 18, the security device 12 may wirelessly communicate, as shown in FIG. 3, with the alarm module 13, the analytics module 11 and/or the emitter 15. Data communication among the various components within the system 10 may be implemented in accordance with a wireless networking protocol, e.g. IEEE 802.11. The analytics module 11, the alarm module 13 and/or the emitter 15 may be positioned near the display 16 of the product 14. A computer 19, such as, for example, a laptop computer, may be positioned near the display 16, and may be connected to the analytics module 11, the alarm module 13 and/or the emitter 15.

In an embodiment of the present invention, and as shown in FIG. 3, the alarm module 13 may, for example, be programmed to transmit a low frequency signal 30 to the emitter 15 that may request the emitter 15 to transmit a low frequency signal to the security device 12. If the security device 12 is within range of the emitter 15, the security device 12 may receive the low frequency signal 31 from the emitter 15 that may request the security device 12 to transmit a signal to the alarm module 13. The security device 12 may be programmed to then transmit a high frequency signal 32 to the alarm module 13 that may indicate that the security device 12 is located within a range of the emitter 15. Alternatively, if the security device 12 is located outside of the range of the emitter 15, the security device 12 may fail to receive the low frequency signal 31 from the emitter 15 and may thus fail to transmit the high frequency signal 32 to the alarm module 13. The alarm module 13 may be programmed to produce an audio alarm and/or a visual alarm if the alarm module 13 fails to receive the high frequency signal 32 from the security device 12. Additionally, the security device 12 may be programmed to emit an audio alarm and/or a visual alarm if the security device 12 fails to receive the low frequency signal 31 from the emitter 15.

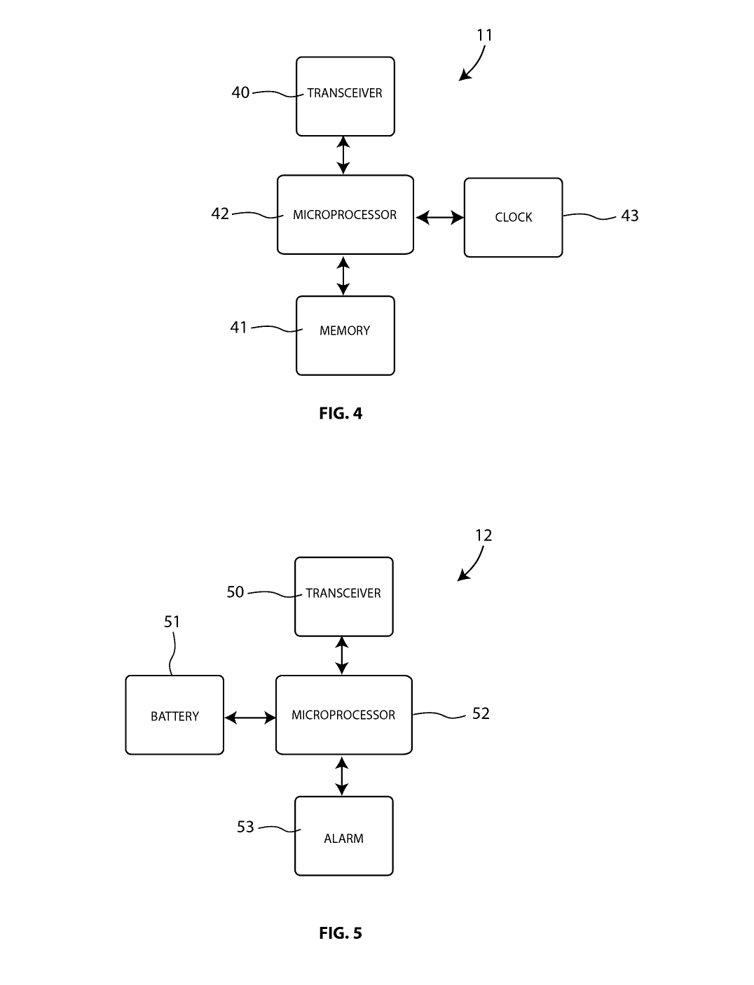

As shown in FIGS. 1 and 4, the analytics module 11 may be programmed to monitor and/or to collect data within the system 10. In an embodiment of the present invention, the analytics module 11 may be placed and/or mounted near the display 16 of the product 14. As shown in FIG. 4, the analytics module 11 may have electronic components. For example, the analytics module 11 may have a transceiver 40 to transmit and/or to receive wireless signals. Additionally, a microprocessor 42 may be programmed to monitor, to capture and/or to log data communicated in the system 10. For instance, the analytics module 11 may be programmed to capture data transmitted from the security device 12, the alarm module 13 and/or the emitter 15. In an embodiment of the present invention, the analytics module 11 may be connected to the alarm module 13. A memory 41, e.g. NVRAM, EEPROM, DDR4 SDRAM and/or the like, may store the data for data collection and/or for analysis.

In an embodiment of the present invention, the microprocessor 42 of the analytics module 11 may be programmed to manipulate the captured data and/or to determine statistical data. Statistical data may be, for example, indicative of a quantity of lifts of the product, a frequency of lifts of the product and/or a duration of lifts of the product. A clock 43 of the analytics module 11 may identify the time of day of a lift, the time of day of a return and/or may time a lift duration.

As shown in FIGS. 1 and 5, the security device 12 may be programmed to wirelessly transmit status data in the system 10 using a high frequency signal. The status data may be, for example, position status and/or alarm status of the security device 12. The security device 12 may be attached to the product 14, for example, via an adhesive. Further, the security device 12 may be electrically connected to a port (not shown) of the product 14 via, for example, a USB cable 17. Removal of the security device 12 from the product 14 and/or removal of the USB cable 17 from the port of the security device 12 may activate an alarm 53 of the security device 12. Alarm 53 may produce an audio alarm and/or a visual alarm. In the docked position, as shown in FIG. 1, the security device 12 and/or the product 14 may receive power via the base 18 and/or the retractable cable. As shown in FIG. 5, the security device 12 may have a transceiver 50 to transmit and/or receive wireless signals. The alarm 53 of the security device 12 may activate if the security device 12, for instance, fails to receive the low frequency signal 31 from the emitter 15. When the security device 12 is removed from the docked position, as shown in FIG. 2, a rechargeable battery 51, e.g. lithium-ion, NiMH, NiCd and/or the like, of the security device 12 may provide power to the security device 12 and/or the product 14. Additionally, the security device 12 may have a microprocessor 52 that may be programmed, for example, to detect a position status and/or an alarm status of the security device 12.

As shown in FIG. 6, the alarm module 13 may be configured using a key 61. For instance, the key 61 may deactivate an alarm condition of the alarm module 13. As shown in FIG. 7, the alarm module 13 may have electronic components. For example, a transceiver 70 may transmit and/or receive wireless signals. Further, the alarm module 13 may have a microprocessor 71 that may be programmed to detect the high frequency signal 32 and/or transmit, via the transceiver 70, the low frequency signal 30. Additionally, the microprocessor 71 may be programmed to activate an alarm 72 during an alarm condition of the alarm module 13 and/or of the security device 12. The alarm 72 may produce an audio alarm and/or a visual alarm.

The emitter 15 may have a transceiver (not shown) to transmit and/or receive wireless signals. Additionally, the emitter may have a microprocessor (not shown) that may be programmed to receive and/or detect the low frequency signal 30 from the alarm module 13. Further, the microprocessor of the emitter 15 may be programmed to transmit, via the transceiver of the emitter 15, the low frequency signal 31.

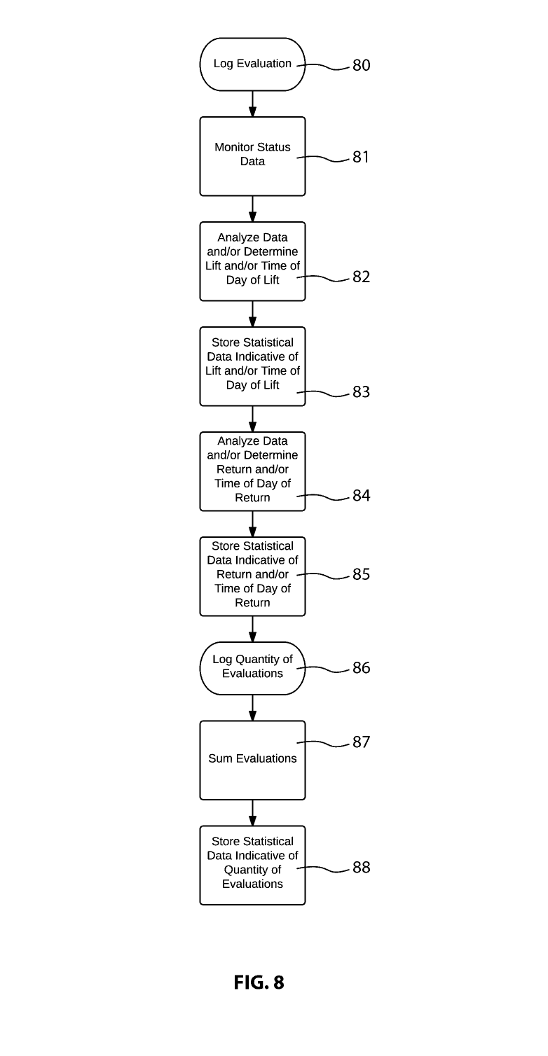

In a retail store, for example, the analytics module 11 may be programmed to monitor status data transmitted in the system 10 and/or to determine statistical data corresponding to the product 14. For instance, in an embodiment of the present invention, and as shown in FIG. 8 at step 80, the analytics module 11 may be programmed to log an evaluation of the product 14. As shown in FIG. 1, the product 14 may be displayed in a static, i.e. docked, position on the display 16 and/or the base 18. As shown in FIG. 2, a consumer may lift the product 14 from the display 16 and/or the base 18. The microprocessor 52 of the security device 12 may be programmed to detect the lift of the product 14 from the base 18. After the lift of the product 14 from the base 18, the security device 12 may be programmed to transmit status data indicative of the lift. As shown in FIG. 8, at step 81, the analytics module 11 may be programmed to monitor the status data transmitted from the security device 12. At step 82, the analytics module 11 may analyze the status data and/or determine a lift of the product 14 and/or a time of day of the lift of the product 14. As shown at step 83, the analytics module 11 may be programmed to store statistical data indicative of the lift and/or the time of day of the lift in the memory 41 for data collection and/or for data analysis.

After evaluating the product 14, a consumer may return the product 14 to the base 18 and/or to the display 16. The microprocessor 52 of the security device 12 may be programmed to detect a return of the product 14 to the base 18. After the return of the product 14, the security device 12 may be programmed to transmit status data indicative of the return of the product 14. At step 84, the analytics module 11 may analyze the data and/or determine a return and/or a time of day of the return of the product 14. As shown at step 85, the analytics module 11 may store statistical data indicative of the return and/or the time of the return in the memory 41 for data collection and/or for data analysis.

As shown in FIG. 8 at step 86, the analytics module 11 may be programmed to log a quantity of evaluations of the product 14. The product 14 may be evaluated, i.e. lifted from and/or returned to the display 16, multiple times within any time period. For each respective evaluation of the product 14, the security device 12 may be programmed to transmit status data indicative of each respective evaluation. The analytics module 11 may monitor and/or collect the status data for each respective evaluation. At step 87, the analytics module 11 may be programmed to sum each evaluation of the product 14 to determine the quantity of evaluations of the product 14. As shown at step 88, the analytics module 11 may be programmed to store statistical data indicative of the quantity of evaluations in the memory 41 for data collection and/or for data analysis.

As shown in FIG. 9 at step 90, in an embodiment of the present invention, the analytics module 11 may be programmed to log a duration of an evaluation of the product 14. For instance, as shown at step 91, the analytics module 11 may be programmed to determine the duration of an evaluation by subtracting the time of day of the lift of the product 14 from the time of day of the return of the product 14. In another embodiment, the clock 43 of the analytics module 11 may time the lift to determine the evaluation duration. As shown at step 92, the analytics module 11 may be programmed to store statistical data indicative of the duration of the evaluation in the memory 41 for data collection and/or for data analysis.

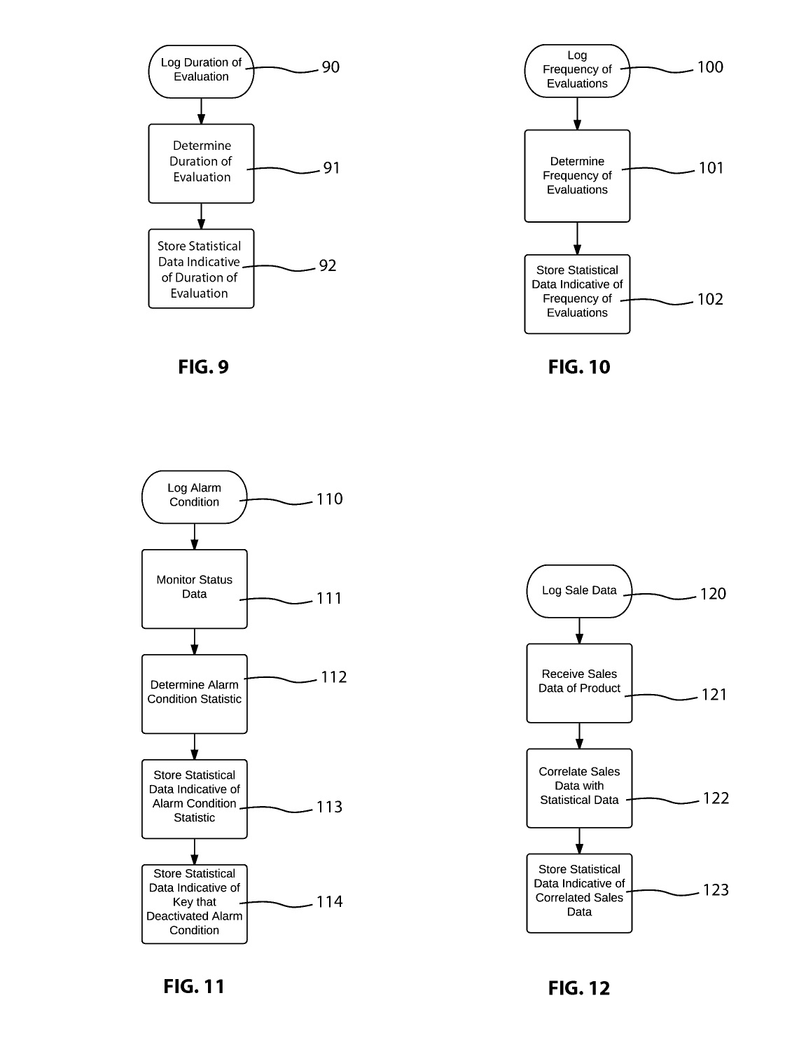

As shown in FIG. 10 at step 100, in an embodiment of the present invention, the analytics module 11 may be programmed to log a frequency of evaluations of the product 14. For instance, as shown at step 101, the analytics module 11 may be programmed to determine the frequency of evaluations of the product 14 by dividing the quantity of evaluations of the product 14 by a time period. The time period may be, for example, an hour and/or a day. At step 102, the analytics module 11 may be programmed to store statistical data indicative of the frequency of evaluations in the memory 41 for data collection and/or for data analysis.

As shown in FIG. 11 at step 110, in an embodiment of the present invention, the analytics module 11 may be programmed to log an alarm condition. The security device 12 and/or the alarm module 13 may be programmed to transmit status data indicative of the alarm condition. Various instances may result in the alarm condition. For example, the microprocessor 52 of the security device 12 may be programmed to activate the alarm 53 if the security device 12 is located in a position outside of the range of the emitter 15. Moreover, if the security device 12 is removed from the product 14, the plunger switch may extend and/or activate the alarm 53 of the security device 12. Also, the security device 12 may be programmed to activate the alarm 53 if the USB cable 17 is removed from the port of the product 14. Additionally, the alarm module 13 may be programmed to activate the alarm 72 of the alarm module 13 if the alarm module 13 fails to receive the high frequency signal 32 from the security device 12. The key 61 may deactivate the alarm condition of the security device 12 and/or the alarm module 13. The security device 12 and/or the alarm module 13 may be programmed to transmit status data indicative of the key 61 that may have been used to deactivate the alarm condition.

As shown at step 111, the analytics module 11 may be programmed to monitor the status data transmitted from the security device 12 and/or the alarm module 13. As shown at step 112, the analytics module 11 may be programmed to determine an alarm condition statistic, such as for example, a quantity and/or a frequency of alarm conditions of the security device 12. At step 113, the analytics module may be programmed to store statistical data indicative of the alarm condition. Further, as shown at step 114, the analytics module 11 may be programmed to store statistical data indicative of the key 61 that may have been used to deactivate the alarm 53 and/or the alarm 72 in the memory 41 for data collection and/or for data analysis.

As shown in FIG. 12 at step 120, in an embodiment of the present invention, the analytics module 11 may be programmed to log sale data. For example, as shown in step 121, the analytics module 11 may be programmed to receive sales data of the product 14. The sales data may be, for example, data indicative of the total number of sales of the product 14 at the retail store using the display 16. The retailer, for example, may input the sales data to the analytics module 11. Further, the analytics module 11 may read the sales data into the memory 41. As shown at step 122, the analytics module 11 may be programmed to correlate the sales data with statistical data, such as, for example, the quantity of evaluations of the product 14. As shown in step 123, the analytics module 11 may be programmed to store statistical data indicative of the correlated sales and statistical data in the memory 41 for data collection and/or for data analysis.

The analytics module 11 may be programmed to monitor status data that may be transmitted in the system 10 and/or to determine statistical data from the status data. In another embodiment of the present invention, the analytics module 11 may be programmed to monitor status data and/or to transmit the status data to the computer 19 that may be programmed to process the status data. For example, the analytics module 11 may be connected to the computer 19. In another embodiment of the present invention, the analytics module 11 may be programmed to wirelessly transmit status data and/or statistical data to the computer 19. The computer 19 may be programmed to determine statistical data of the product 14 and/or to display data to a user in, for example, the retail store. The analytics module 11 may be programmed to transmit the status data and/or the statistical data in real-time, and the computer 19 may be programmed to update the statistical data. The statistical data may be, for example, the quantity of evaluations, the frequency of evaluations and/or the duration of evaluations of the product 14. Further, the statistical data may be the number of alarm conditions of the product 14. Still further, the computer 19 may be programmed to display a battery status of the security device 12. The computer 19 may be programmed to display the statistical data corresponding to the product 14 that may be attached to the security device 12 and may be programmed to display a user assignable name of the security device 12. The user assignable name may be, for example, a designation of the product 14 that may be attached to the security device 12. For example, rather than displaying an internet protocol and/or a media access control address of the security device 12, the computer 19 may be programmed to display the statistical data in association with a user assignable name of the product 14 that may be attached to the security device 12.

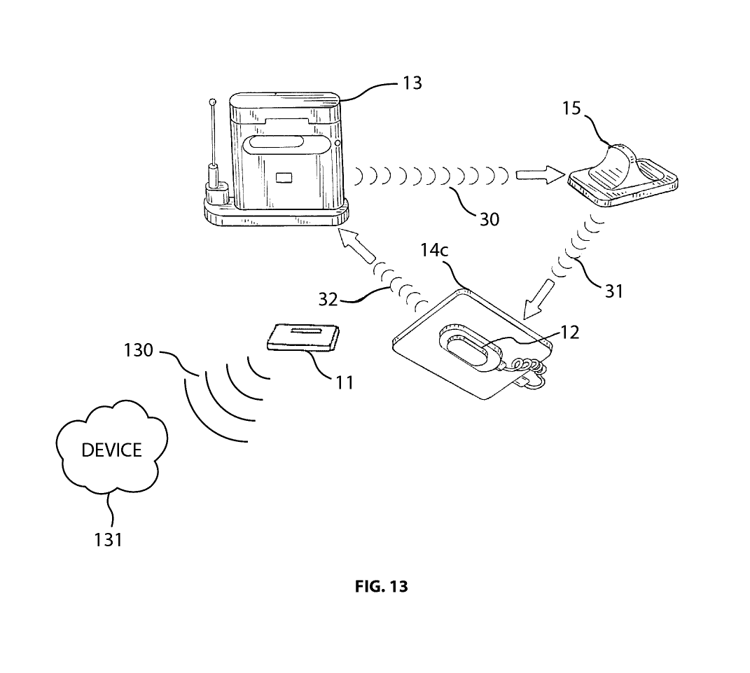

As shown in FIG. 13, in an embodiment of the present invention, the analytics module 11 may be programmed to wirelessly transmit data 130 to a remote device 131. The remote device 131 may be, for example, a server, a computer and/or a mobile device. The remote device 131 may be located, for example, at a location remote from the retail store. In an embodiment of the present invention, the analytics module 11 may be programmed to transmit the data 130 periodically, such as, for example, at a defined time interval. In another embodiment of the present invention, the analytics module 11 may be programmed to transmit the data 130 in response to a condition. For example, the analytics module 11 may be programmed to transmit an alarm update in response to an alarm condition of the security device 12 and/or the alarm module 13. The alarm update may be transmitted as, for example, an email and/or an SMS message. The data 130 may be, for example, the statistical data, such as the quantity of evaluations, the frequency of evaluations, the duration of evaluations and/or the correlated sales data of the product 14. In an embodiment of the present invention, the remote device 131 may log on and/or may access the analytics module 11 and may view the statistical data and/or the status data of the product 14 and/or the security device 12 in real-time. Further, the remote device 131 may request the statistical data from the analytics module 11 and/or the computer 19.

It should be understood that various changes and modifications to the embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

I claim:

1. A system for wirelessly collecting data corresponding to a product on a display for purchase of the product, the system comprising:
a security device attached to the product;
a first transceiver associated with the security device wherein the first transceiver wirelessly transmits status data wherein the status data is indicative of a position of the product; and
an analytics module positioned remotely from the security device wherein the analytics module receives the status data and determines statistical data from the status data wherein the statistical data is indicative of a number of lifts of the product wherein a lift corresponds to removal of the product from the position.

2. The system of claim 1 further comprising:
a second transceiver associated with the analytics module wherein the second transceiver wirelessly transmits the statistical data.

3. The system of claim 1 further comprising:
a base associated with the display wherein the base docks the security device.

4. The system of claim 1 further comprising:
an alarm associated with the security device wherein the alarm produces a signal indicative of a disconnect of the security device from the product.

5. The system of claim 1 further comprising:
a computer connected to the analytics module wherein the computer collects the statistical data.

6. The system of claim 1 further comprising:
an alarm module that receives the status data.

7. An apparatus for wirelessly collecting data corresponding to a product connected to a security device wherein the product is in a static position and removable to a lifted position, the apparatus comprising:
an analytics module positioned remotely from the security device wherein the analytics module receives status data from the security device wherein the status data is indicative of whether the product is in the static position or the lifted position and further wherein the analytics module determines statistical data from the status data; and
a transceiver associated with the analytics module wherein the transceiver wirelessly transmits the statistical data.

8. The apparatus of claim 7 further comprising:
a computer connected to the analytics module wherein the analytics module transmits the statistical data to the computer.

9. The apparatus of claim 7 further comprising:
an alarm module positioned remotely from the security device wherein the security device transmits a wireless signal to the alarm module.

10. The apparatus of claim 7 further comprising:
an emitter positioned remotely from the security device wherein the emitter transmits a wireless signal to the security device.

11. The apparatus of claim 7 further comprising:
a clock associated with the analytics module wherein the clock identifies a time of day of removal of the product from the static position.

12. The apparatus of claim 7 further comprising:
a memory associated with the analytics module wherein the memory stores the statistical data.

13. A method for wirelessly collecting data corresponding to a product connected to a security device, the method comprising the steps of:
receiving a wireless signal from the security device wherein the wireless signal conveys status data wherein the status data is indicative of a position of the product;
determining a lift of the product wherein the lift corresponds to removal of the product from the position;
determining statistical data from the status data wherein the statistical data is indicative of a number of lifts of the product; and
wirelessly transmitting the statistical data.

14. The method of claim 13 further comprising the step of:
determining an evaluation duration of the product that is indicative of a time of the lift of the product.

15. The method of claim 13 further comprising the step of:
determining a removal time of the product that is indicative of a time of day of the lift of the product.

16. The method of claim 13 further comprising the step of:
activating an alarm when the security device is removed from the product.

17. The method of claim 13 further comprising the step of:
determining an evaluation frequency that is indicative of a number of times the product is lifted.

18. The method of claim 13 further comprising the step of:
determining an alarm frequency that is indicative of a number of times an alarm associated with the security device is triggered.

19. The method of claim 13 further comprising the step of:
storing the statistical data in a memory.

20. The method of claim 13 further comprising the step of:
receiving a request for the statistical data.
